(19) United States
(12) Patent Application Publication
(10) Pub. No.: US 2014/0304121 A1
(43) Pub. Date: Oct. 9, 2014

(54) COMPUTER DEVICE FOR SELLING PRODUCTS

(71) Applicant: YO YO PROMO LIMITED, Lancashire (GB)

(72) Inventor: Jason Miles Alexander Cropper, Lancashire (GB)

(21) Appl. No.: 14/357,714

(22) PCT Filed: Nov. 12, 2012
(86) PCT No.: PCT/GB2012/052800

§ 371 Date: May 12, 2014

(30) Foreign Application Priority Data
Nov. 11, 2011 (GB) 1119487.5

(51) Int. Cl. G06Q 30/06

(52) U.S. Cl. CPC G06Q 30/0641
USPC 705/27.1

(57) ABSTRACT

The invention relates to a system for creating a market for selling products. The system comprises a first user input unit operable to receive one or more parameters from a first user, a configuration unit operable to configure a graph of price variation against time from parameters supplied by the first user input units, a graphic unit, configured to provide a graph or data for a graph of price variation against time to a second user, a current price display unit configured to calculate a current price from the graph and to display the current price to the second user, and a purchase unit configured to receive an instruction from the second user to purchase a product at the current price displayed by the current price display unit.

### BACKGROUND

1. Technical Field

The present invention relates generally to the field of online purchasing. More particularly, the present invention relates to a method and apparatus for making adjustment to prices of products when selling products over the internet.

2. Description of Related Art

Products are sold over the internet by means of a personal computer, which typically comprises an input unit which a vendor uses to specify a price of the product, a display unit operable to display the price of a product to a customer, and a purchase unit configured to receive an instruction from the customer to purchase a product at the price displayed by display unit. Typically, the display unit and purchase unit are implemented to communicate to the customer by means of a web page, which is commonly defined using Hyper-Text Mark-up Language (HTML).

The customer visiting the web page typically either purchases the product at the displayed price or decide not to purchase. However, the customer generally does not spend much time on the Web page, and is therefore less likely to browse other products, view any advertising on the Web page, and/or return to the Web page to make repeat purchases.

It is known to use computers to sell products via the internet by auction methods, wherein a price of a product increases according to bids made by customers. When using such methods customers are known to spend significantly more time on the Web page due to the interest they generate. In this method, the price a product sells for is generally controlled by the bids of other customers, rather than its vendor.

Therefore, the inventors have identified a desire to provide a system for selling products over the internet, with the increased interest that auction methods provide, but where the vendor is more able to control the price at which unit is sold.

The exemplary embodiments have been provided with a view to addressing at least some of the difficulties that are encountered in current computer devices, whether those difficulties have been specifically mentioned above or will otherwise be appreciated from the discussion herein.

### SUMMARY OF THE INVENTION

According to the present invention there is provided a system for creating a market for selling products comprising:

a first user input unit operable to receive one or more parameters from a first user;

a configuration unit operable to configure a graph of price variation against time from parameters supplied by the first user input unit;

a graphics unit, configured to provide a graph or data for a graph of price variation against time to a second user;

a current price display unit configured to calculate a current price from the graph and to display the current price to the second user;

a purchase unit configured to receive an instruction from the second user to purchase a product at the current price displayed by the current price display unit.

Preferably, the parameters comprise one or more of the following pieces of information: initial price; maximum discount to apply to the initial price; minimum discount to apply to the initial price; mean discount, start time of graph; end time of graph; termination command; the discount to apply in relation to specific quantities of remaining stock.

Preferably, the first user is a seller. Preferably, there are a plurality of second users, who are customers. Preferably, the price relates to on or more goods and/or services. Preferably, the first user input is a computer. Preferably, the system is a website run by the first user an accessed by the second users. The graph or data for a graph is preferably provided for a time period up to a present time.

Preferably, the graphics unit and/or current price display unit is operable to display a run-time of the graph and/or a count-down of the time remaining.

Preferably, the current price display unit is operable to indicate how long the discount applies for and/or a count down of the time remaining at the particular discount.

Preferably, the graph starts at an undiscounted price.

Preferably, the graphics unit is operable to update the graph at time increments selected by the first user.

Preferably, the current price display unit is operable to display the undiscounted price and/or current discount applied.

Preferably, the current price display unit is operable to display a purchase history of goods/service.

Preferably, the current price display unit is operable to display details of the goods/services.

Preferably, the purchase unit is operable to freeze a price of the goods/services for a set time period during purchase. Preferably, the purchase unit is operable to indicate to the second user when the price is due to unfreeze, preferably by means of a count-down timer.

Preferably, the website is operable to display a graph of price variation against time and current price for a plurality of goods and/or services.

Preferably, the configuration unit is configured such that the first user can change the parameters in real time.

According to a further aspect of the present invention, there is provided a method of creating a market for selling products, the method comprising:

a first user inputting one or more parameters into a first user input unit;

a configuration unit configuring a graph of price variation against time from parameters supplied by the first user input unit;

a graphics unit displaying the graph of price variation against time to a second user;

a current price display unit calculating a current price from the graph and displaying the current price to the second user;

the second user instructing a purchase unit to purchase a product at the current price displayed by the current price display unit.

According to another aspect of the invention there is provided a computer program product carrying instructions which when run on a computer are operable to perform the method of the preceding aspect.

Any of the above described features may be taken in any combination and with any aspect of the invention.

### BRIEF DESCRIPTION OF THE DRAWINGS

For a better understanding of the invention, and to show how exemplary embodiments may be carried into effect, reference will now be made to the accompanying drawings in which:

FIG. 1 is a schematic overview of an example system for selling products in which the exemplary embodiments may be applied;

FIG. 2 is a schematic diagram showing the example system in more detail;

FIG. 3 is a schematic diagram showing the example system in more detail;

FIG. 4 is a schematic diagram showing the example system in more detail; and

FIG. 5 is a graph showing a Gaussian function.

### DETAILED DESCRIPTION OF THE EXEMPLARY EMBODIMENTS

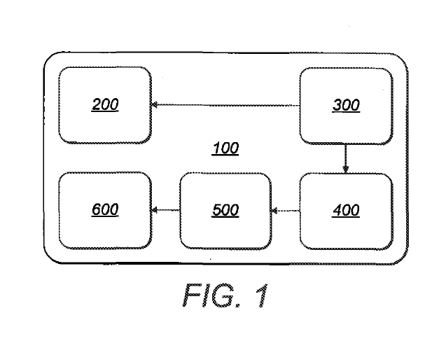

FIG. 1 shows a schematic overview of a computer device 100 according to an exemplary embodiment of the present invention. In this example, the device 100 includes a first user input unit 200 operable to receive one or more parameters from a first user, a configuration unit 300 operable to configure a graph of price variation against time from parameters supplied by the first user input unit 200, a graphics unit 400, configured to display the graph of price variation against time to a second user; a current price display unit 500 configured to calculate a current price from the graph and to display the current price to the second user; a purchase unit 600 configured to receive an instruction from the second user to purchase a product at the current price displayed by the current price display unit.

The first user input 200 includes an interface between a first user 700 and the computer device 100. In use, parameters 800, which are discussed in more detail below, are input into the first user input 200 by the first user 700, who is typically the seller of an article, which herein is defined as goods/services. This may be achieved by any known user/computer interface, such as a keyboard or mouse.

The parameters 800 can be any one or more of the following sales conditions for an article: initial price of the article; maximum discount to apply to the initial price; minimum discount to apply to the initial price; mean discount, start time of a graph; end time of a graph; sales termination command; the discount to apply in relation to specific quantities of remaining stock; and other parameters which control the shape of the graph, such as period and skew, as described in more detail below.

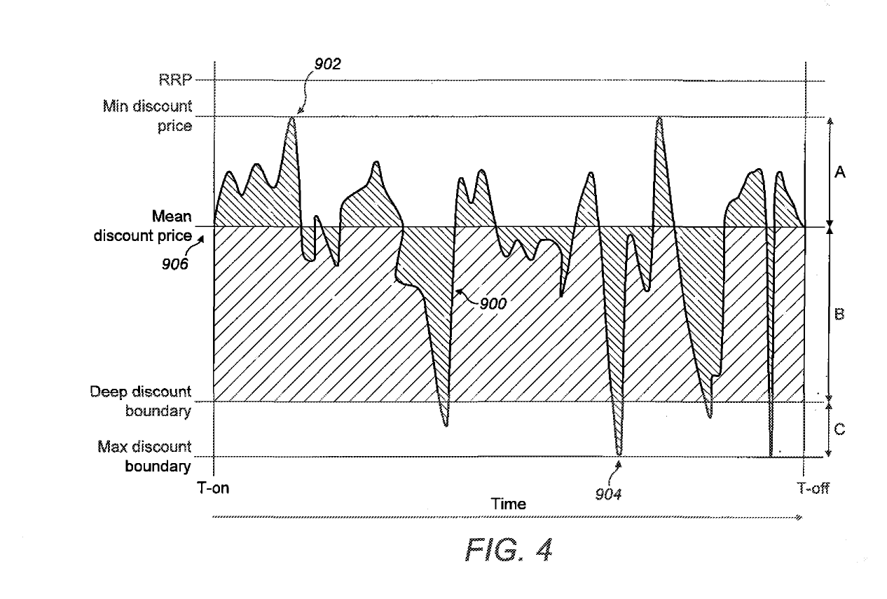

The parameters 800 are supplied from the first user input 200 to the configuration unit 300, by which they are used to generate a graph 900 of price variation against time (i.e. the discount applied to the original price against time), as shown in FIG. 4. The graph 900 can be generated by any known function, such as a polynomial, exponential or trigonometric. However, in a preferred embodiment it is generated from a normal distribution/Gaussian function.

The Gaussian function

$$f ( x ) = ae - \frac{{( x - b )}^{2}}{2 {c}^{2}}$$

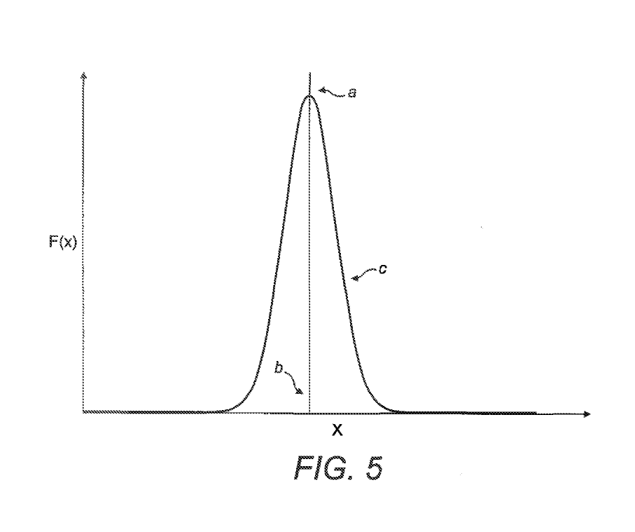

is plotted in FIG. 5 and is a characteristic ‘bell curve’. The parameter a is the height of the curve's peak, b is the position on the centre of the peak, and c controls the width of the curve. In a known development of the above equation the curve may also be skewed.

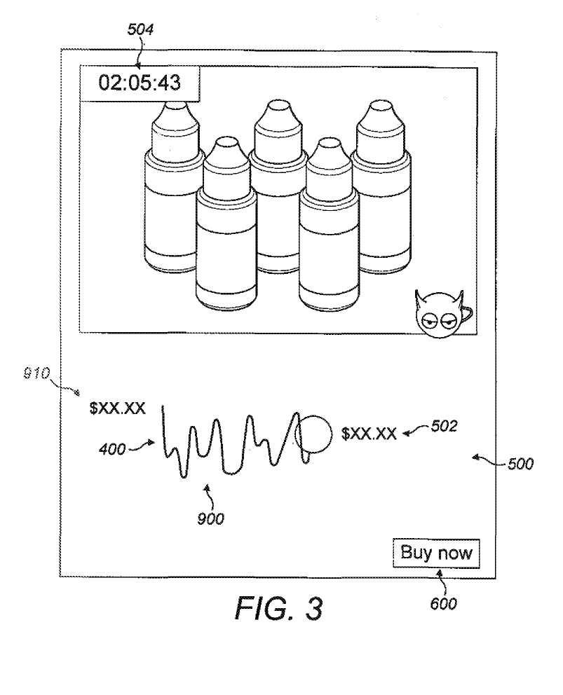

Accordingly, a plurality of normal distribution curves can be combined to provide the graph as shown in FIGS. 3 and 4. The variables, a, b, and c are selected for each curve such that the graph 900 is shaped to provide the desired price variation against time. For instance, the minimum discount is selected by setting parameter a (the height of the peak of the curve 902). In this same way, the maximum discount is selected by setting parameter a (the height of inverted peak of curves 904). In this example curves have been added/subtracted/skewed to provide the desired shape.

The curves are also controlled such that a mean discount price occurs at line 906, wherein the integral of the discount price versus time along the means discount price line is zero. Furthermore, the curves are controlled such that for a set period of time the graph 900 is within a predetermined discount range. For instance, from FIG. 4 the discount may remain within band A, which is between the minimum and mean discount for 20-30 percent of the time, within band B, which is between a deep discount boundary and mean discount for 50-60 percent of the time, and within band C, which is between the deep discount boundary and maximum discount for the remainder of the time.

The first user 700 is also able to enter parameters such that the device is operable to allocate a predefined number of sales at a particular discount. This is achieved by allowing the purchase unit to complete the predefined number of sales at the particular discount, thereafter the graph 900 is reconfigured such that it does not pass through the particular discount range.

The first user 700 is also able to specify an predefined average discount to be applied to the last n articles to be sold, for instance the last 30 articles may have a mean discount of 40 percent. This is achieved by entering total the number of articles as a parameter 800, and monitoring the number of remaining articles by subtracting the number of sales recoded by the purchase unit 600 from the to the total number of articles. When the number of remaining articles reduced to n, the graph 900 can be re-configured such that required mean discount is achieved.

The graph 900 is displayed to the second user 1000, by means of the graphics unit 400, which is operable to interface with the second user 1000. Here there second user is a buyer of the article, generally there are a plurality of second users 1000. In this example the graphics unit is operable to interface with the second user 100 via a display means such as a computer monitor, as shown in FIG. 3.

The current price display unit 500 calculates a price 502 of the article in real-time from the graph 900. The price 502 is displayed to the second user 1000, by means of the current price display unit 500, which is operable to interface with the second user 100. In this example the price display unit 500 is operable to interface with the second user 100 via a display means such as a computer monitor, as shown in FIG. 3.

The purchase unit 600 includes an interface between a second user 1000 and the computer device 100. This may be achieved by any known user/computer interface, such as a keyboard or mouse. In use, the second user 1000 provides an instruction to purchase the article via the purchase unit at the price displayed by the price display unit 500.

According to one embodiment, the current price display unit includes a timer 504 (FIG. 3) which is operable to display the amount of time the graph has been running for and/or a countdown timer which indicates to the second user 1000 how much time is left to run on the graph or how long a the current price applies for.

According to a preferred embodiment, the graph 900 initiates at an un-discounted price, as indicated by point 910 on FIG. 3. In this way the second user can identify the potential reduction.

The graphics unit 300 is configured to update the graph 900 at predefined time intervals selected by the first user 700 as a parameter 800. In this way the parameters 800 that control the shape of the graph can be adjusted in real-time to alter the shape of the graph as required, with the graph 900 being re-plotted to display the new parameters.

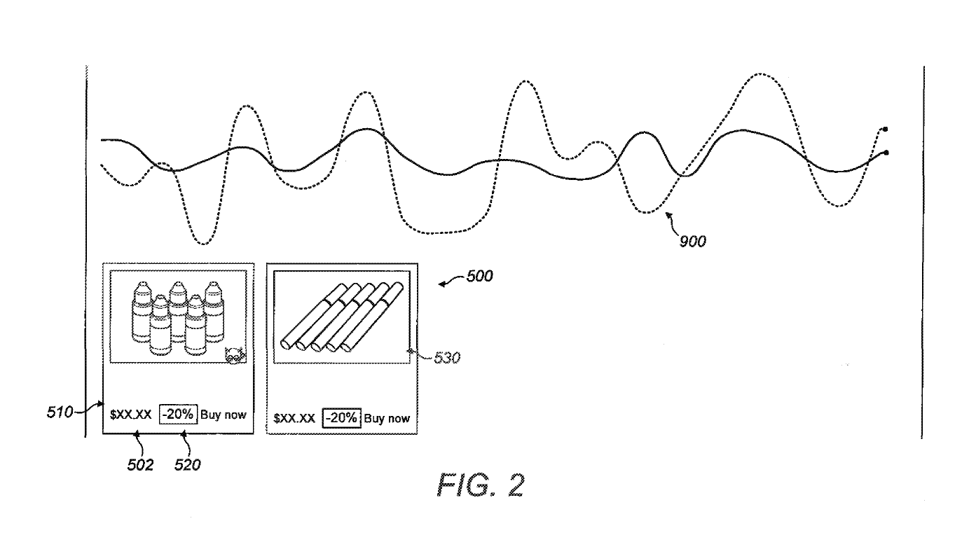

According to a preferred embodiment as shown in FIG. 2, the current price display unit 500 is operable to display the undiscounted price 510 and percentage discount 520, which is calculated from the graph 900. The current price display unit 500 is also operable to display details 530 of the article, which may include an image of the article, technical specifications, the manufacturer's details, and a link to further information such as the manufacturer's web site. In this way the second user can correctly identify the article which is being purchased.

According to one embodiment (not shown) the current price display unit displays the purchase history of articles to the second user 1000. In this way the second user can see the quality of products soled at a particular discount.

The purchase unit 600 is operable to freeze the purchasing price of the article for a time period which may be specified as a parameter 800. In this way, the second user 1000 has a finite time period to complete purchase of the article at the discounted price. The purchase unit 600 has a countdown timer which indicates to the second user how much time they have to complete the purchase. According to the exemplary embodiment, the instruction to purchase is specified by the second user 1000 to the purchase unit 600 via a display means such as a computer monitor, as shown in FIG. 3.

In this exemplary embodiment, the current price display unit 500, graphics unit and purchase unit are all operable to interface though the same web browser with the second user. Furthermore, the web browser is operable to display the graph of price variation against time, current price and purchase unit for several articles, as shown in FIG. 2.

In summary, the exemplary embodiments have described improved apparatus and method for selling products on a website, implemented by means of the first user running a website that controls products offered and prices available, and web users use web browsers to view and purchase products. The industrial application of the exemplary embodiments will be clear from the discussion herein.

Although a few preferred embodiments have been shown and described, it will be appreciated by those skilled in the art that various changes and modifications might be made without departing from the scope of the invention, as defined in the appended claims.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A system for creating a market for selling products comprising:
a first user input unit operable to receive one or more parameters from a first user;
a configuration unit operable to configure a graph of price variation against time from parameters supplied by the first user input unit;
a graphics unit, configured to provide a graph or data for a graph of price variation against time to a second user;
a current price display unit configured to calculate a current price from the graph and to display the current price to the second user; and
a purchase unit configured to receive an instruction from the second user to purchase a product at the current price displayed by the current price display unit.

2. The system as claimed in claim 1, wherein the parameters comprise one or more of the following pieces of information: initial price; maximum discount to apply to the initial price; minimum discount to apply to the initial price; mean discount, start time of graph; end time of graph; termination command; the discount to apply in relation to specific quantities of remaining stock.

3. The system as claimed in claim 1, wherein the first user is a seller.

4. The system as claimed in claim 1, wherein there are a plurality of second users, who are customers.

5. The system as claimed in claim 1, wherein the price relates to one or more goods and/or services.

6. The system as claimed in claim 1, wherein the first user input is a computer.

7. The system as claimed in claim 1, wherein the system is a website run by the first user an accessed by the second users.

8. The system as claimed in claim 1, wherein the graph or data for a graph is preferably provided for a time period up to a present time.

9. The system as claimed in claim 1, wherein the graphics unit and/or current price display unit is operable to display a run-time of the graph and/or a count-down of the time remaining.

10. The system as claimed in claim 1, wherein the current price display unit is operable to indicate how long the discount applies for and/or a count down of the time remaining at the particular discount.

11. The system as claimed in claim 1, wherein the graph starts at an undiscounted price.

12. The system as claimed in claim 1, wherein the graphics unit is operable to update the graph at time increments selected by the first user.

13. The system as claimed in claim 1, wherein the current price display unit is operable to display the undiscounted price and/or current discount applied.

14. The system as claimed in claim 1, wherein the current price display unit is operable to display a purchase history of goods/service.

15. The system as claimed in claim 1, wherein the current price display unit is operable to display details of the goods/services.

16. The system as claimed in claim 1, wherein the purchase unit is operable to freeze a price of the goods/services for a set time period during purchase.

17. The system as claimed in claim 1, wherein the purchase unit is operable to indicate to the second user when the price is due to unfreeze, preferably by means of a count-down timer.

18. The system as claimed in claim 7, wherein the website is operable to display a graph of price variation against time and current price for a plurality of goods and/or services.

19. The system as claimed in claim 1, wherein the configuration unit is configured such that the first user can change the parameters in real time.

20. A method of creating a market for selling products, the method comprising:
a first user inputting one or more parameters into a first user input unit;
a configuration unit configuring a graph of price variation against time from parameters supplied by the first user input unit;
a graphics unit displaying the graph of price variation against time to a second user;
a current price display unit calculating a current price from the graph and displaying the current price to the second user; and
the second user instructing a purchase unit to purchase a product at the current price displayed by the current price display unit.

21. A computer program product carrying instructions which when run on a computer are operable to perform the method as claimed in claim 20.

22. (canceled)

23. Computer recordable medium comprising the computer program as claimed in claim 21.
